(19) United States
(12) Patent Application Publication
(10) Pub. No.: US 2007/0085468 A1
(43) Pub. Date: Apr. 19, 2007

(54) Image display unit

(75) Inventors: Akiyoshi Nakamura, Saitama-ken (JP); Tomoko Kozuka, Gunma-ken (JP); Takeo Ito, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, TOKYO (JP)

(21) Appl. No.: 10/579,761

(22) PCT Filed: Nov. 17, 2004
(86) PCT No.: PCT/JP04/17092

§ 371 Date: Dec. 18, 2006

(30) Foreign Application Priority Data
Nov. 20, 2003 (JP) 2003-390507

(51) Int. Cl. H01J 63/04; H01J 1/62

(52) U.S. Cl. 313/496; 313/495; 313/485

(57) ABSTRACT

This image display device includes a rear plate having a large number of electron emission elements and a face plate placed opposite to the rear plate and having a pattern of a phosphor layer and a pattern of a light absorption layer (a black matrix), on an inner surface of a light transmissive panel. Each pattern portion of the phosphor layer has a polygonal shape obtained by cutting corners from a quadrangle concentric with the light emitting portion which receives electron beams emitted from electron emission elements to emit light. Further,the area of each pattern portion of the phosphor layer can be 1.5 to 4 times the area of the light emitting portion The image display device is capable of display of high quality with high contrast and without decrease in brightness.

### TECHNICAL FIELD

The present invention relates to an image display device such as a field emission display (FED) or the like.

### BACKGROUND ART

In an image display device such as a cathode-ray tube (CRT) or a field emission display (FED), a pattern of a phosphor layer of three colors of blue (B), green (G), and red (R) in dots or stripes is formed on an inner surface of a glass panel constituting a face plate so that electron beams collide against the pattern of the phosphor layer to cause phosphors to emit light, whereby image display is performed.

On a display surface of the above-described image display device, a light absorption layer (a black layer) is provided as a black matrix between phosphor dots or phosphor stripes which are adjacent pixels in order to absorb light from outside the phosphors and increase the image contrast.

The light absorption layer is formed, for example, by applying a photoresist to the inner surface of the glass panel, exposing it under a predetermined pattern mask and developing it to form a resist pattern in dots or strips corresponding to the pattern of the phosphor layer, and thereafter applying and binding a dispersion liquid containing light absorbing material such as a black pigment onto the resist pattern, and subsequently dissolving and stripping the resist and the layer of the light absorption material thereon using a decomposer such as hydrogen peroxide solution or a sulfamic acid solution (see, for example, Patent Document 1).

In a flat image display device such as an FED having the above-described display surface, however, sufficiently satisfactory panel characteristics such as brightness and contrast cannot be obtained in the present circumstances.

Specifically, since only the region of each pattern portion of the phosphor layer to which electrons emitted from electron emission elements are projected emits light in the FED, it is difficult to obtain high contrast. Accordingly, a method of decreasing the transmittance of the glass panel is employed to increase the contrast, which method, however, causes a problem of decreasing the brightness.
Patent Document 1: JP-A No. Hei 8-236036 (KOKAI)

### DISCLOSURE OF THE INVENTION

The present invention has been developed to solve the above-described problems, and its object is to provide an image display device capable of display of high quality with high contrast and without decrease in brightness.

A first aspect of the present invention is an image display device comprising a rear plate having a large number of electron emission elements formed in a predetermined arrangement, and a face plate placed opposite to the rear plate and having a pattern of a phosphor layer formed in a predetermined arrangement and a pattern of a light absorption layer formed as a black matrix, on an inner surface of a light transmissive panel, wherein each pattern portion of the phosphor layer is composed of a light emitting portion receiving electron beams emitted from the electron emission elements projected thereto to emit light and a non-light emitting portion formed in a periphery of the light emitting portion, and each pattern portion has a polygonal shape obtained by cutting corners from a quadrangle concentric with the light emitting portion.

A second aspect of the present invention is an image display device comprising a rear plate having a large number of electron emission elements formed in a predetermined arrangement and a face plate placed opposite to the rear plate and having a pattern of a phosphor layer formed in a predetermined arrangement and a pattern of a light absorption layer formed as a black matrix, on an inner surface of a light transmissive panel, wherein each pattern portion of the phosphor layer is composed of a light emitting portion receiving electron beams emitted from the electron emission elements projected thereto to emit light and a non-light emitting portion formed in a periphery of the light emitting portion, and an area of each pattern portion is 1.5 to 4 times an area of the light emitting portion.

In the present invention, the image contrast is increased as well as the brightness hardly decreases and is maintained at a level substantially equal to that of the conventional one. Accordingly, an image display device can be realized which is capable of display of high quality with high brightness and high contrast.

### BRIEF DESCRIPTION OF DRAWINGS

FIG. 1 is a cross-sectional view schematically showing the structure of an FED that is one embodiment of the present invention; and

FIGS. 2A to 2C are enlarged views showing shapes of patterns of a phosphor layer and a light absorption layer of a phosphor screen in the FED, FIG. 2A and FIG. 2B illustrating a first and a second embodiment respectively, and FIG. 2C illustrating the shape of a pattern in a conventional phosphor screen.

### BEST MODE FOR CARRYING OUT THE INVENTION

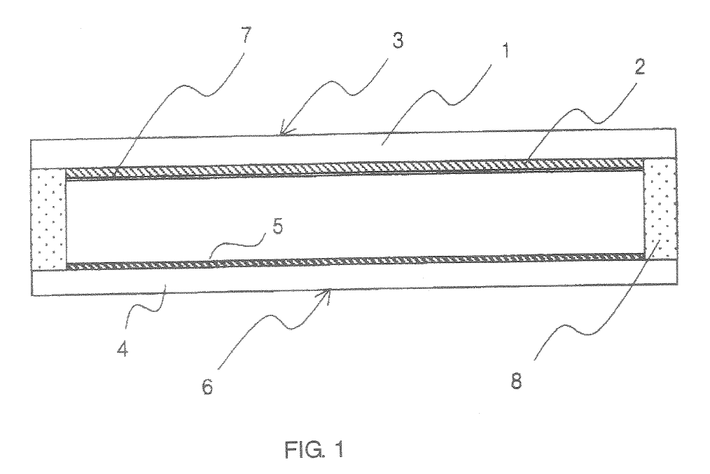

Embodiments for carrying out the present invention will be described below. FIG. 1 shows an FED that is one embodiment of the present invention.

In this FED, a face plate 3 having a phosphor screen 2 on an inner surface of a light transmissive panel 1 such as a glass substrate and a rear plate 6 having many electron emission elements 5 arranged in a matrix on a substrate 4 which face each other with a very narrow gap of approximately from one millimeter to several millimeters intervening there between, and a high voltage from 5 kV to 15 kV is applied across the gap.

The phosphor screen 2 is composed of a pattern of a phosphor layer in dots formed in a predetermined arrangement and a pattern of a light absorption layer comprised of a black pigment such as carbon formed as a black matrix. On the phosphor screen 2, a metal back layer 7 made of a metal film such as an Al film is formed. Numeral 8 in the drawing denotes a support frame (a sidewall).

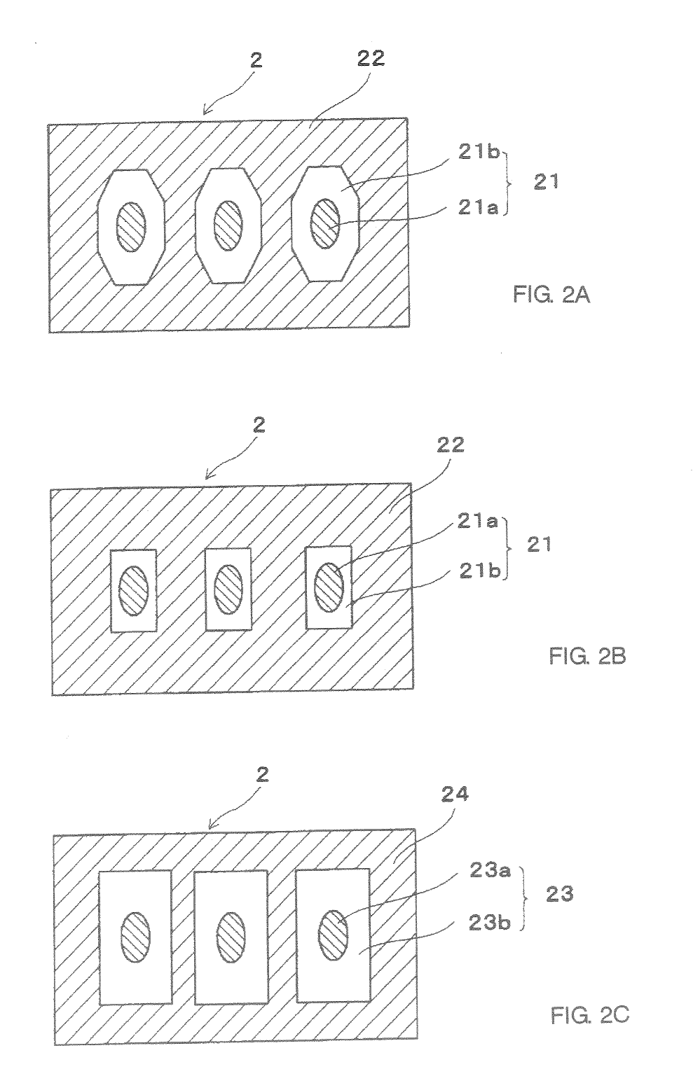

Enlarged shapes of the patterns of the phosphor layer and the light absorption layer of the phosphor screen 2 in this embodiment are shown in FIGS. 2A and 2B. Further, the shapes of the patterns of the phosphor screen 2 in a conventional FED are shown in FIG. 2C.

In FIG. 2A and FIG. 2B, numeral 21 denotes the pattern of the phosphor layer formed in dots (hereinafter referred to as a phosphor dot). The phosphor dots of three colors of red (R), green (G), and blue (B) are repeatedly arranged in this order in the direction of length and the transverse direction. A pattern 22 of the light absorption layer is provided as a black matrix in a manner to fill spaces between the phosphor dots 21.

Each of the phosphor dots 21 is composed of a light emitting region 21a receiving electrons emitted from electron emission elements arranged and formed on the rear plate projected thereto to emit light and a non-light emitting region 21b in the periphery of the light emitting region 21a, the light emitting region 21a having a circular or an elliptical shape. It should be noted that numeral 23 denotes a phosphor dot and numeral 24 denotes a pattern of a light absorption layer that is a black matrix in FIG. 2C. The phosphor dot 23 in a quadrangular shape is composed of a light emitting region 23a and a non-light emitting region 23b.

In a first embodiment, as shown in FIG. 2A, each of the phosphor dots 21 surrounded by the pattern 22 of the light absorption layer being the black matrix has a polygonal shape (for example, an octagonal shape) obtained by cutting four corners from the quadrangular shape that is the shape of the phosphor dot 23 in the conventional FED (shown in FIG. 2C). The area of each phosphor dot 21 is significantly reduced relative to the area of the conventional phosphor dot 23.

In the first embodiment, the shape of the phosphor dot 21 is an octagon that has more corners than the quadrangular shape of the conventional one and has a reduced area relative to that of the conventional phosphor dot 23. In other words, the pattern 22 of the light absorption layer being the black matrix is formed to cover the non-light emitting region 21b as much as possible so as to significantly reduce the area of the non-light emitting region 21b, resulting in increased display contrast of an image. Further, the brightness hardly decreases and therefore can be maintained at a level substantially equal to that of the conventional one.

It should be noted that the shape of the phosphor dot 21 is not limited to the octagonal shape obtained by cutting all of the four corners from a quadrangle. Any shape obtained by cutting at least one of the four corners of the quadrangle can offer such effect. Further, each phosphor dot 21 is formed in a polygon having a larger number of corners than the octagon, in which as the shape is made closer to a circle or ellipse that is the shape of the light emitting region 21a, the display contrast increases. In terms of easiness in pattern formation, the shape can be the octagon preferably.

In a second embodiment, as shown in FIG. 2B, the phosphor dot 21 has a quadrangular shape that is similarly reduced relative to the conventional quadrangular shape shown in FIG. 2C, in which the area of each phosphor dot 21 is adjusted to fall within 1.5 to 4 times the area of the light emitting region 21a. It should be noted that the area of each phosphor dot 23 is four times the area of the light emitting region 23a or greater (for example, 4.4 times) in the conventional phosphor screen 2.

In this embodiment, the shape of the phosphor dot 21 may be a polygonal shape obtained by cutting the corners from a quadrangle which is concentric with the light emitting region 23a, or an ellipse or circle.

As the area of each phosphor dot 21 is made closer to 1 time the area of the light emitting region 21a to reduce as much as possible the area of the non-light emitting region 21b, the display contrast increases in theory. However, when the area of the phosphor dot 21 is less than 1.5 times the area of the light emitting region 21a, lack of beam may occur at a part on the screen due to defect of alignment between the phosphor dots 21 and the electron emission elements, causing disadvantages such as deterioration of brightness or deterioration of uniformity. Accordingly, it is preferable to adjust the area of the phosphor dot 21 to 1.5 to 4 times, more preferably to 1.7 to 3.7 times the area of the light emitting region 21a.

In a third embodiment of the present invention, its shape of each phosphor dot 21 can be an octagon and its area can fall within 1.5 to 4 times the area of the light emitting region 21a.

Next, a method of forming the phosphor screen 2 in the first to third embodiments will be described.

The pattern 22 of the light absorption layer that is the black matrix is formed first, for example, by a photolithography method. More specifically, a photoresist containing polyvinyl alcohol (PVC) and dichromate such as ammonium dichromate (ADC) as main components is coated on the inner surface of the glass substrate and dried to form a photosensitive film. Ultraviolet light is applied to the photosensitive film through a photomask with a predetermined pattern to thereby expose it. After the exposure, the photosensitive film is developed with pure water to form a resist pattern, and a dispersion liquid containing a light absorbing material such as graphite and a dispersant is applied and bound to the resist pattern Subsequently, a decomposer containing 10 wt % of sulfamic acid is used to dissolve the resist and the layer of the light absorbing material thereon to separate them.

In the pattern of the light absorption layer formed as described above, a pattern of a phosphor layer of three colors of red (R), green (G), and blue (B) is formed by a method such as the photolithography method (the slurry method) using a phosphor slurry or a screen printing of a resin paste containing phosphor.

To form the phosphor layer of each color by the slurry method, after a blue phosphor slurry is applied on the black matrix and dried to form a coating of the blue phosphor on the entire inner surface of the glass substrate, the coating is subjected to exposure and development through the mask, and uncured portion of the coating is removed by washing, whereby the blue phosphor layer is formed at a predetermined position. Subsequently, in a similar manner, a green phosphor layer and a red phosphor layer are formed in sequence. A slurry used herein as the blue phosphor slurry contains a blue phosphor (ZnS: Ag, Al) and PVA (polyvinyl alcohol) and dichromate as main components with a surfactant added thereto. A slurry used as the green phosphor slurry contains a green phosphor (ZnS: Cu, Al) and PVA and dichromate as main components with a surfactant added thereto. A slurry usable as the red phosphor slurry contains a red phosphor (Y₂O₂S: Eu) and PVA and dichromate as main components with a surfactant added thereto.

To form the metal back layer 7 on the phosphor screen 2 thus formed, a method (a lacquer method) can be employed which involves vacuum depositing the metal film such as an Al film on a thin film made of an organic resin, for example, nitrocellulose or the like formed by a spin method, and then baking the film to remove organic matter.

It is also possible to form the metal back layer by a transfer method using stacked films (a transfer film) for transfer shown below. The transfer film has a structure in which a metal film of Al or the like and an adhesive layer are stacked in order on a base film with a release agent layer (a protecting film as necessary) intervening therebetween. The transfer film is disposed such that the adhesive layer is in contact with the phosphor layer and the light absorption layer, and subjected to pressing process. Pressing methods include a stamp method, a roller method, and so on. Thus, the transfer film is pressed while being heated so that the metal film adheres to the phosphor layer and the light absorption layer, and the base film is stripped followed by heating and baking of the remaining film to decompose or remove the organic matter, whereby the metal film can be formed on the phosphor screen.

In the FEDs of the first to third embodiments of the present invention, the non-light emitting region 21a other than the light emitting region 21a actually effectively emitting light in each phosphor dot 21 is covered by the pattern 22 of the light absorption layer as much as possible in order to function as a black matrix, resulting in a significant increase in image contrast. Further, the brightness hardly decreases and therefore can be maintained at a level substantially equal to that of the conventional one.

### EXAMPLES

Next, specific examples of the present invention will be described.

### Example 1

A pattern of the light absorption layer that was a black matrix and a pattern of the phosphor layer (phosphor dots) were formed on the inner surface of a glass substrate respectively by the photolithography method to fabricate a phosphor screen. In this events the pattern of phosphor screen was formed such that, as shown in FIG. 2A, the shape of each phosphor dot 21 surrounded by the light absorption layer being the black matrix was an octagon obtained by cutting four corners from a quadrangle and the area of the phosphor dot 21 was 2.8 times the area of the light emitting region 21a.

Subsequently, a metal back layer was formed on the phosphor screen by the transfer method. More specifically, an Al transfer film in which an Al film was stacked on a base film made of a polyester resin with a releasing agent layer Intervening therebetween and coated with an adhesive layer thereon was placed such that the adhesive layer is in contact with the phosphor surface, and the Al transfer film was heated and pressed from above using a heating roller for adhesion. Next, the base film was stripped so that the Al film adhered to the phosphor surface, and the Al film was then heated at 450° for 30 minutes for baking so that the organic matter was decomposed or removed therefrom. Thus, a substrate (a panel) having the phosphor surface with the metal back layer formed by transfer was obtained.

Subsequently, with the use of the substrate having the phosphor surface with the metal back thus obtained, an FED was fabricated. More specifically, an electron emitting source having a large number of electron-emission elements of a surface conductive type formed on a substrate in a matrix was fixed to a rear glass substrate to thereby constitute a rear plate The rear plate and the above-described panel (face plate) were placed opposite to each other with a support frame and spacers intervening therebetween and sealed with frit glass. The gap between the face plate and the rear plate was 2 mm. Then, required processing such as evacuation, sealing were performed to complete an FED.

Display characteristics such as the brightness and contrast of the obtained FED were measured by a general method. The measurement results are shown in Table 1.

### Example 2

As shown in FIG. 2B, a phosphor surface with a metal back layer was formed as in the example 1 other than that the shape of each phosphor dot 21 was a quadrangle and the area of the phosphor dot 21 was 2.1 times the area of the light emitting region 21a. Subsequently a panel having the phosphor surface with the metal back was used to fabricate an FED. Further as a comparative example, a phosphor surface with a metal back layer was formed such that the shape of each phosphor dot was a quadrangle and the area of the phosphor dot was 4.4 times the area of the light emitting region, and a panel having the phosphor surface with the metal back was used to fabricate an FED.

Next, the brightness and contrast of the FEDs obtained in the examples 1 and 2 and comparative example were measured by a general method. The measurement results are shown in Table 1. Note that in evaluation of the brightness and contrast shown in Table 1, (***) indicates very high evaluation, (**) indicates excellent evaluation, and (*) indicates evaluation at the practicable level but desired to be improved.

TABLE 1

| | | | COMPARATIVE |
|---|---|---|---|
| | EXAMPLE 1 | EXAMPLE 2 | EXAMPLE |
| Contrast | ** | *** | * |
| Brightness | ** | ** | ** |

As is understandable from Table 1, the FEDs obtained in the examples 1 and 2 had increased contrasts without deterioration of brightness and thus had higher display quality as compared to the conventional FED obtained in the comparative example.

### INDUSTRIAL APPLICABILITY

As has been described, according to the present invention, the image contrast can be increased as well as the brightness hardly decreases and is maintained at a level substantially equal to that of the conventional one. Consequently, display of high quality with high brightness and high contrast can be realized and preferable for CRT and FED.

What is claimed is:

1. An image display device, comprising:
a rear plate having a large number of electron emission elements formed in a predetermined arrangement; and
a face plate placed opposite to the rear plate and having a pattern of a phosphor layer formed in a predetermined arrangement and a pattern of a light absorption layer formed as a black matrix, on an inner surface of a light transmissive panel,
wherein each pattern portion of the phosphor layer is comprised of a light emitting portion receiving electron beams emitted from the electron emission elements projected thereto to emit light and a non-light emitting portion formed in a periphery of the light emitting portion, and the each pattern portion has a polygonal shape obtained by cutting corners from a quadrangle concentric with the light emitting portion.

2. The image display device as set forth in claim 1, wherein an area of the each pattern portion of the phosphor layer is 1.5 to 4 times an area of the light emitting portion.

3. An image display device, comprising:
a rear plate having a large number of electron emission elements formed in a predetermined arrangement; and
a face plate placed opposite to the rear plate and having a pattern of a phosphor layer formed in a predetermined arrangement and a pattern of a light absorption layer formed as a black matrix on an inner surface of a light transmissive panel,
wherein each pattern portion of the phosphor layer is composed of a light emitting portion receiving electron beams emitted from the electron emission elements projected thereto to emit light and a non-light emitting portion formed in a periphery of the light emitting portion, and an area of the each pattern portion is 1.5 to 4 times an area of the light emitting portion.
